(19) United States
(12) Patent Application Publication
(10) Pub. No.: US 2026/0137579 A1
(43) Pub. Date: May 21, 2026

(54) Wearable Personal Stabilization System with Gyroscopic Stabilizers

(71) Applicant: Vincent Loccisano, Wellesley, MA (US)

(72) Inventor: Vincent Loccisano, Wellesley, MA (US)

(21) Appl. No.: 19/452,158

(22) Filed: Jan. 16, 2026

(51) Int. Cl. A61H 3/00

(52) U.S. Cl. CPC A61H 3/00; A61H 2003/007; A61H 2201/1215; A61H 2201/165; A61H 2201/5007; A61H 2205/08; A61H 2230/625

(57) ABSTRACT

An example embodiment of the present invention is a wearable stabilization device comprising a carrier configured to be worn by a human user. Housed within this carrier are one or more gyroscopic stabilization elements, each containing a rotatable mass and a motor or actuator designed to rotate the mass or reorient its spin axis. A sensor subsystem is integrated to detect state information regarding orientation, motion, gait phase, or interactions between the user and the environment. A control subsystem is operatively coupled to both the sensor subsystem and the gyroscopic stabilization elements. This control subsystem processes the sensed state information to determine necessary corrective commands and operates the gyroscopic elements to apply corrective torques to the carrier, thereby assisting in stabilizing the wearer.

### TECHNICAL FIELD OF THE INVENTION

The present disclosure relates generally to wearable stabilization devices and systems. More particularly, the disclosure relates to wearable carriers—such as backpacks, waist packs, belts, vests, harnesses, and garments—that integrate gyroscopic stabilization elements, sensor arrays, power and motor subsystems, and control logic configured to generate corrective torques. These systems assist a user in maintaining balance, preventing falls, and providing targeted physical therapy or exercise assistance.

### BACKGROUND OF THE INVENTION

Compromised postural stability and balance are widespread issues, particularly among the elderly and individuals with specific medical conditions, such as vestibular dysfunction, neuropathy, Parkinson's disease, or stroke sequelae. These conditions significantly predispose individuals to trips, slips, and falls. Consequently, falls remain a leading cause of traumatic injury, morbidity, reduced independence, and escalating healthcare costs.

Conventional approaches to fall prevention and balance assistance generally fall into two categories: passive aids and active systems. Passive aids, such as canes, walkers, and hip protectors, rely heavily on the user's manual operation and vigilance. Active systems, such as wearable airbags and powered exoskeletons, attempt to intervene during a fall or assist movement. However, these existing solutions suffer from significant drawbacks that limit user acceptance and clinical effectiveness. Many devices are heavy, bulky, or stigmatizing, resulting in impractical power-to-weight trade-offs. Furthermore, most conventional aids fail to provide continuous, real-time corrective torque to actively stabilize the user's center of mass before a catastrophic loss of balance occurs.

While gyroscopic devices including reaction wheels and control moment gyroscopes, are well-established in aerospace and vehicular stabilization, they have not been widely adapted for unobtrusive, wearable human-assistive systems. Prior art attempting to apply gyroscopic principles to human stabilization has been limited by prohibitively large form factors, excessive weight, high power consumption, control complexity, and safety concerns regarding interaction with the user. Accordingly, there remains a need in the art for a wearable stabilization system that integrates gyroscopic elements into ergonomic, socially acceptable carriers, provides adaptive multi-axis stabilization, and incorporates safety and power-management features suitable for daily use.

Recent advancements in electrochemical energy storage and electric motor technology have fundamentally altered the feasibility landscape for compact, wearable gyroscopic systems. Modern lithium-ion and related high-energy-density battery chemistries now offer sufficient energy per unit mass to enable multi-hour operation of active stabilization modules without imposing prohibitive pack weight.

Improvements in Battery Management Systems (BMS), fast-charging protocols, and thermal management allow for the safe integration of power sources into garments proximate to the user's torso. In parallel, advances in compact electric motors—specifically brushless DC (BLDC) motors featuring high power-to-weight ratios—and the development of lightweight rotor materials (e.g., carbon-fiber reinforced flywheels) permit the generation of high angular momentum with reduced mass and acoustic signature. These technological developments enable the practical embodiment of wearable gyroscopic stabilizers that were previously unachievable using earlier generations of batteries and motors.

### SUMMARY OF THE INVENTION

An example embodiment of the present invention is a wearable stabilization device comprising a carrier configured to be worn by a human user. Housed within this carrier are one or more gyroscopic stabilization elements, each containing a rotatable mass and a motor or actuator designed to rotate the mass or reorient its spin axis. A sensor subsystem is integrated to detect state information regarding orientation, motion, gait phase, or interactions between the user and the environment. A control subsystem is operatively coupled to both the sensor subsystem and the gyroscopic stabilization elements. This control subsystem processes the sensed state information to determine necessary corrective commands and operates the gyroscopic elements to apply corrective torques to the carrier, thereby assisting in stabilizing the wearer.

In preferred embodiments, the wearable stabilization device leverages state-of-the-art battery and motor technologies to achieve practical trade-offs among runtime, torque capability, weight, and safety. For instance, high-energy-density battery modules, such as modern lithium-ion pouch or prismatic cells with integrated battery management systems, are utilized to supply peak current for rapid rotor acceleration during event-triggered assists. These power sources simultaneously support multi-hour average runtimes during continuous assist modes. Rotor actuation is implemented using compact brushless DC motors featuring high pole counts and precision motor drivers that enable high-speed rotation with closed-loop speed control. Alternatively, advanced low-commutation-loss brushed motors may be employed for cost-sensitive variants. To further optimize efficiency, the motor controllers implement regenerative techniques during controlled spin-down sequences to reclaim energy and reduce net power consumption.

The invention further contemplates configurable therapy and exercise modes that intentionally introduce controlled perturbations or resistive torques to the wearer. These modes serve to promote balance training, postural strengthening, gait rehabilitation, and targeted exercise. Such operational modes may be clinician-programmable, user-selectable, or adaptive. They leverage the gyroscopic elements to provide graduated levels of assistance, perturbation-based training, and resistive loading for strength training, while also performing data logging for progress assessment.

Some embodiments enable the application of torques in one, two, or three axes, including pitch, roll, and yaw, or any subset thereof. This is achieved through various configurations such as single-axis reaction wheels, orthogonal reaction wheel arrays, gimbaled control moment gyroscopes, distributed micro-reaction wheel arrays, or hybrid combinations. The system further includes sensor fusion utilizing components such as inertial measurement units, foot-contact sensors, pressure sensors, and optional environmental sensors. The device operates via adaptive control algorithms, including proportional-integral-derivative controllers, model predictive control, or adaptive and learning-enabled controllers. Finally, the system incorporates safety subsystems to enforce torque and speed limits alongside mechanical containment, user interfaces for on-device or smartphone connectivity, and power management features including peak-power scheduling and regenerative braking.

### BRIEF DESCRIPTION OF DRAWINGS

FIG. 1 is an external perspective view of a lumbar pack incorporating a gyroscopic stabilization module;

FIG. 2 is an internal exploded view showing a tri-orthogonal reaction wheel array;

FIG. 3 is an illustration of a CMG module;

FIG. 4 is a schematic block diagram of electronics and sensor architecture;

FIG. 5 is a flowchart of control hierarchy and loops;

FIG. 6 is a distributed reaction wheel array embedded in a garment;

FIG. 7 is a safety subsystem block diagram;

FIG. 8 is a timing diagram illustrating sensor sampling and torque-command updates;

FIG. 9 is an example therapy/exercise mode flowchart and clinician interface schematic.

### DETAILED DESCRIPTION OF THE INVENTION

The present invention provides a wearable stabilization system comprising one or more gyroscopic stabilization elements integrated within a wearable carrier. The system utilizes sensor fusion and real-time control circuitry to generate corrective torques configured to assist a wearer in maintaining postural stability. The gyroscopic stabilization elements may be embodied in various configurations to accommodate specific user requirements and device form factors; such configurations include, but are not limited to, single-axis reaction wheels, orthogonal reaction wheel arrays, gimbaled control moment gyroscopes (CMGs), distributed micro-reaction wheels, and passive flywheels with damping mechanisms. Furthermore, the WSS incorporates high-energy-density power sources and high-torque motor assemblies to facilitate a safe, ergonomic, and wearable architecture. In addition to active stabilization, the system may provide automated therapy and exercise routines designed for musculoskeletal strengthening and balance rehabilitation.

Preferred embodiments enable application of torques in one, two, or three axes (pitch, roll, yaw), or any subset thereof, using single-axis reaction wheels, orthogonal reaction wheel arrays, gimbaled control moment gyroscopes (CMGs), distributed micro-reaction wheel arrays, or hybrid combinations. The system further includes sensor fusion (IMUs, foot-contact sensors, pressure sensors, optional environmental sensors), adaptive control algorithms (PID/PD, MPC, adaptive/learning-enabled controllers), safety subsystems (torque and speed limits, controlled spin-down, mechanical containment), user interfaces (on-device and smartphone connectivity), and power management (BMS, peak-power scheduling, regenerative braking.

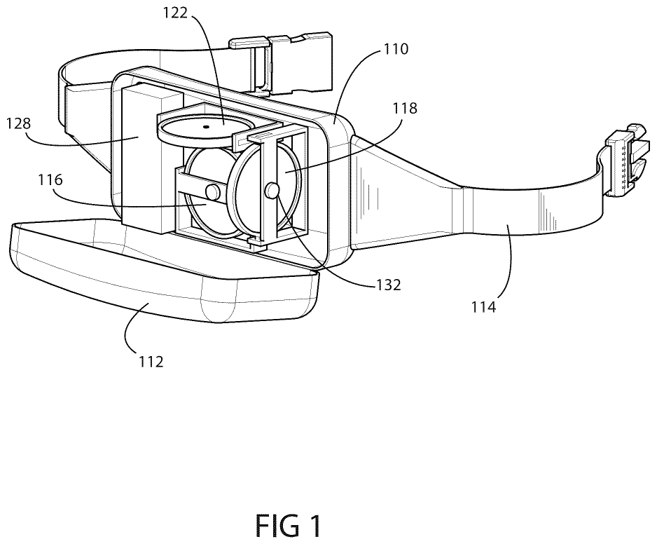

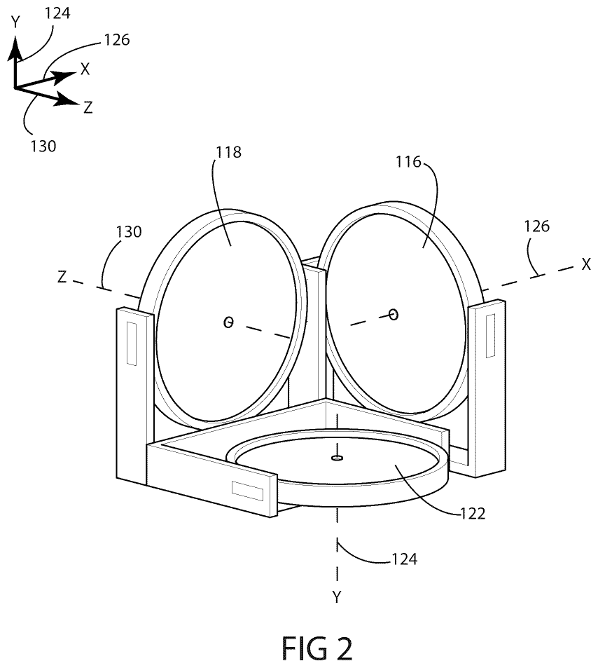

A set of gyroscope stabilization elements are depicted in the illustrations in FIG. 1 and FIG. 2. In FIG. 1, a wearable carrier has a compartment 110. a cover 112 and a fastening means 114. The wearable carrier is configured to be worn by the user. One skilled in the art understands that the wearable carrier in the illustration may be worn about the waist and that other wearable carriers configured to be worn over the shoulder, shoulders or the like may also be within the scope of the invention. One or more gyroscopic stabilization elements are housed within the carrier. Each gyroscopic stabilization element has a rotatable mass and a motor or actuator configured to rotate the rotatable mass. For example, rotatable mass 118 is driven by a motor/actuator 132 (FIG. 1). In some embodiments gyroscopic stabilization elements align with Cartesian axis X, Y and Z. In this example embodiment a first gyroscopic stabilization element 116 is aligned with an X-axis 126, a second gyroscopic stabilization element 118 is aligned with an Z-axis 130, and a third gyroscopic stabilization element 124 is aligned with an Y-axis 124. A housing 128 houses a sensor system, controller and power source. A sensor system is configured to sense state information related to orientation, motion, gait phase or user-environment interactions.

A controller is operatively coupled to the sensor system and the gyroscopic stabilization elements. The control system is configured to determine corrective torque commands based on the sensed state information and to operate the gyroscopic stabilization elements to apply corrective torques to the carrier to assist in stabilizing the wearer. This orthogonal reaction wheel array has at least three wheels configured about orthogonal axes, allowing independent torque generation in pitch, roll and yaw.

At least one inertial measurement unit located in the housing 128 is configured to measure torso orientation and angular rate. the controller computes required torque to oppose undesired angular deviations and adjusts individual rotor speeds to produce a net torque. Foot-contact sensors provide gait-phase information to reduce interference during normal gait cycles and to appropriately time assist during stance phases.

In other embodiments, a therapy mode permits clinician-configured perturbation sequences (magnitude/direction/timing) to train reactive balance or resistive torque profiles to strengthen trunk musculature.

The battery pack supplies peak currents for rapid rotor accelerations during event-triggered assists and therapy perturbations; regenerative braking recovers energy during spin-down to extend runtime.

In one embodiment only one gyroscopic stabilization element 116 is engaged with the wearable carrier. The wearable carrier contains a single high-momentum reaction wheel with spin axis aligned to apply torque in the roll axis to resist lateral perturbations. Foot-contact sensors provide gait-phase information to reduce interference during normal gait cycles and to appropriately time assist during stance phases. Exercise mode applies graded resistive torque opposing lateral lean to strengthen hip abductors/adductors and trunk stabilizers; mode progression increases resistive torque in small increments as the user demonstrates improved stability.

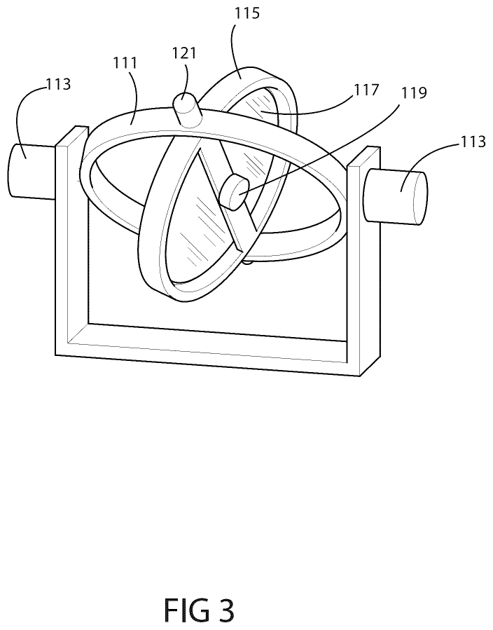

FIG. 3 is an illustration of a Control Moment Gyroscope (CMG). A frame supports at least one motor(s) 113 that control the rotation of outer ring 111, also referred to as a gimbal. The gimbal rotates about a first axis that is concentric with motor(s) 113. In some embodiments, an inner ring 115, also referred to as a second gimbal, rotates about a second axis that is perpendicular to the first axis. The rotation of the inner ring 115 is controlled by a second motor or set of motors 121. A flywheel 117 is driven by a flywheel motor 119 and rotates within the second ring 115 about an axis that is perpendicular to the second axis. Reorientation of the rotor axis produces gyroscopic precession torque orthogonal to the gimbal motion and the rotor's spin axis. CMGs provide high transient torque for a given rotor angular momentum and are useful when stronger perturbations or resistive exercises are required or when a more compact assembly, than three separate gyroscopes, providing gyroscopic torque is desired.

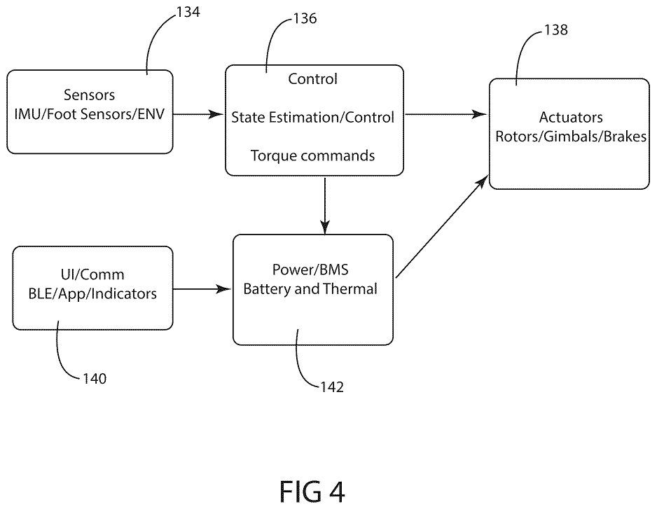

FIG. 4 is a schematic block diagram of electronics and sensor architecture. A sensing subsystem 134 comprises a plurality of primary and secondary sensors configured to monitor the kinematic state of both the wearer and the environment. Primary sensors typically include at least one Inertial Measurement Unit (IMU) disposed on the carrier; in some embodiments, additional IMUs are distributed across the wearer's torso, limbs, or extremities to provide multi-segment motion tracking. Secondary sensors may include force-sensing resistors or load cells for detecting foot-contact and ground reaction forces, pressure sensors integrated into securement straps, and shoe-mounted inertial sensors.

In one embodiment a wearable carrier such as a vest, has Small CMG Modules for Multi-Axis Therapy. A vest, for example, may integrate multiple small CMG modules whose gimbals can be actuated to produce multi-axis precessional torques. Clinician-tunable gains and data logging support rehabilitation protocols including perturbation training, trunk-rotation strengthening, and complex multi-axis balance exercises. Safety-rated containment and supervised session modes minimize risk during aggressive therapy sequences.

To enhance situational awareness, the system may further incorporate environmental sensors—such as LIDAR, ultrasonic rangefinders, and optical proximity or depth sensors—to detect obstacles or anticipate external perturbations. For therapeutic or rehabilitative applications, the subsystem may also integrate physiological sensors (e.g., heart-rate monitors, electromyography (EMG) sensors) and clinician interface devices to facilitate data-driven recovery protocols.

Sensors and Sensing Subsystem Primary sensors typically include at least one IMU mounted on the carrier and, optionally, additional IMUs mounted on the torso and/or limbs. Secondary sensors may include foot-contact sensors (force-sensing resistors, load cells), pressure sensors in straps, inertial sensors on shoes or embedded in socks, optical proximity or depth sensors, and environmental sensors (LIDAR, ultrasonic rangefinders) to detect obstacles or approaching perturbations. For therapy/exercise applications, additional physiological sensors (heart rate, EMG) and clinician input devices may be included.

The system employs a sensor fusion subsystem to synthesize raw signals into a high-fidelity state estimate. Utilizing computational frameworks—such as an Extended Kalman Filter (EKF), Unscented Kalman Filter (UKF), or complementary filtering—the system estimates a plurality of kinematic and stability parameters. These parameters include, but are not limited to, orientation (Euler angles or quaternions), angular velocity, linear acceleration, center-of-pressure (CoP) trajectories, gait phase, and fall-risk probability heuristics.

This state estimation architecture is configured to support a multi-rate control hierarchy, providing high-frequency data to inner control loops for torque stabilization and lower-frequency data for high-level heuristic decision-making. To ensure precision across diverse populations, the system incorporates user-specific biometric profiling—including height, mass distribution, and mobility constraints—to calibrate state estimation algorithms and tune control gains. In therapeutic embodiments, the system analyzes historical logged data and performance metrics, such as time-to-recovery and postural sway amplitude, to dynamically adjust the assistance or resistance levels (difficulty) of rehabilitation protocols.

In some embodiments an electronic device such as a smartphone or watch is controlled by an application to communicate with the sensor fusion subsystem. Information from smartphone multi-axis accelerometers and gyroscopes or the like are communicated to the sensor fusion subsystem to more accurately track the user's movements. The smartphone may be stored in a wearable carrier or may be anywhere on the user's person. The system may further couple with various health tracking applications to derive stabilization needs based on related health data from the health tracking application. In some example embodiments, the combination of stabilization activity and health application information may be used to track a degenerative disease.

The sensing subsystem 134 signals the controller 136. The control subsystem comprises a central processing unit—which may be implemented as a microcontroller, microprocessor, or Field-Programmable Gate Array (FPGA)—coupled with motor drivers configured to drive the rotor and gimbal actuators. The subsystem further includes a memory architecture for the storage of calibration parameters and user profiles, alongside communication interfaces, such as Bluetooth Low Energy (BLE), for data exchange with external devices like smartphones or clinician consoles.

The control architecture is organized into a multi-rate, nested-loop structure. At the lowest level, motor controllers execute high-frequency speed and torque loops for the rotors and position or velocity loops for the gimbals. These low-level loops utilize Proportional-Integral-Derivative (PID) or similar high-performance control laws operating at sample rates typically ranging from 500 Hz to 1 kHz to ensure actuation stability. This feeds into a mid-level attitude stabilization loop, which calculates a desired torque vector based on estimated posture deviations, such as angle and angular rate errors. The mid-level controller issues torque commands to the low-level controllers using PD or PID logic, often employing gain-scheduling techniques to adapt to specific user activities—such as standing or walking—and individual user profiles.

Overseeing these processes, a high-level control layer manages decision logic and mode management. This layer determines the active operating mode, which may include continuous assist, event-triggered assist, therapy/exercise, training, passive, or transport/locked modes. Additionally, the high-level controller supervises safety monitors and manages energy-saving behaviors, such as modulating assistance levels during low-battery states.

The system executes these controls through distinct strategies. In a continuous assist mode, the system provides constant, low-level stabilization to reduce postural sway and provide subtle balance support. Conversely, in an event-triggered assist mode, the system delivers rapid, high-magnitude corrective torque only upon detecting sudden perturbations, such as a slip or trip, that exceed a predefined threshold. Advanced embodiments may also utilize predictive control strategies, such as Model Predictive Control (MPC) or anticipatory logic. These strategies leverage motion prediction—derived from IMU data, gait-phase detection, and environmental cues—to preemptively apply torque before a balance disruption occurs. In the event of a measured fall for example, the system may further assist in providing torque to assist in helping the person back up to a sitting or standing position. In addition, the system may trigger an alert subsystem to alert others in the event of a fall.

In yet other example embodiments, functional features include rapid spin-up for immediate stabilization for transitional motions such as standing up from a seated position. A continuous mode may provide stabilization in a specific direction of stabilization tailored to a specific task such as riding a bicycle or walking.

The control system 136 signals the power system 142 that includes energy storage, battery management system and thermal monitoring. The energy storage system is centered around a rechargeable battery architecture utilizing high-energy-density cells, such as lithium-ion variants or equivalent high-capacity chemistries. The total battery capacity is scaled to the specific operational requirements of the embodiment, ranging from lightweight, lower-capacity packs for daily use (typically in the tens to low hundreds of watt-hours) to higher-capacity modules designed for extended clinical or rehabilitative operation.

To meet the high-torque demands of the system, the battery pack topology is specifically configured for high-rate peak discharge. This involves selecting cells and parallel configurations capable of delivering the transient currents required for rapid rotor acceleration while maintaining voltage stability and preventing excessive sag. These configurations are supported by an integrated thermal management system to ensure safe power delivery during high-load events.

Central to the power subsystem is an integrated Battery Management System (BMS) that monitors critical parameters including individual cell voltages, pack temperature, and state-of-charge (SOC). The BMS is configured to execute cell balancing and enforce safety protocols such as over-current, over-voltage, under-voltage, and thermal protections. Furthermore, the BMS provides real-time telemetry to the primary device controller, enabling SOC-aware power management. This allows the system to dynamically scale assistance levels or initiate a controlled transition to a passive fallback state as energy levels diminish.

Charging functionality is facilitated through standardized interfaces—such as DC barrel connectors or USB-C Power Delivery (PD)—or proprietary fast-charging ports. The charging and power distribution circuitry includes fail-safe isolation and charge cut-offs to protect the wearer. Additionally, the physical enclosure is designed with thermal insulation or heat-dissipation paths to minimize thermal transfer to the wearer's body during high-current charging or peak operation.

To further optimize efficiency, the system incorporates energy reclamation capabilities. During controlled rotor deceleration or braking, the motor drivers are configured to operate in a regenerative mode. This process recaptures a portion of the system's kinetic energy and redirects it back into the primary battery pack or into local capacitive storage, thereby extending the effective runtime and reducing the net power consumption of the device.

The user interface 140 engages with the power system 142 and control system 136 and includes Bluetooth Low Energy (BLE) communication, a software application and a series of indicators. The system incorporates a multi-modal user interface and connectivity suite designed for local control and remote data management. Local interaction is facilitated through on-device controls—such as physical or capacitive mode-selection switches and a dedicated emergency-stop mechanism—supplemented by status indicators, including Light Emitting Diodes (LEDs) or small-format displays. To provide non-visual feedback, the device includes haptic actuators, such as vibration motors, configured to deliver tactile alerts regarding system status, battery levels, or gait-correction cues.

Wireless connectivity, implemented via protocols such as Bluetooth, Wi-Fi, or proprietary RF links, enables the system to interface with external computing devices, including smartphones, tablets, and clinician consoles. In therapeutic and rehabilitative embodiments, these external interfaces operate as specialized clinician applications. These applications allow for the precise configuration of operational parameters, including but not limited to perturbation magnitude, resistive torque profiles, session durations, and performance-based progress thresholds.

The connectivity subsystem further supports the transmission of real-time telemetry and the retrieval of logged kinematic and physiological data. This stored data enables comprehensive post-session analysis, longitudinal progress tracking, and the objective, evidence-based adjustment of therapy protocols. To ensure system longevity and security, the architecture supports over-the-air (OTA) firmware updates and remote parameter tuning, facilitated through encrypted wireless links and authenticated update mechanisms to prevent unauthorized access or unintended modification of control laws.

The power system 142 and control system 136 engage the physical apparatus 138 that includes actuators, rotors, gimbals, brakes and the like.

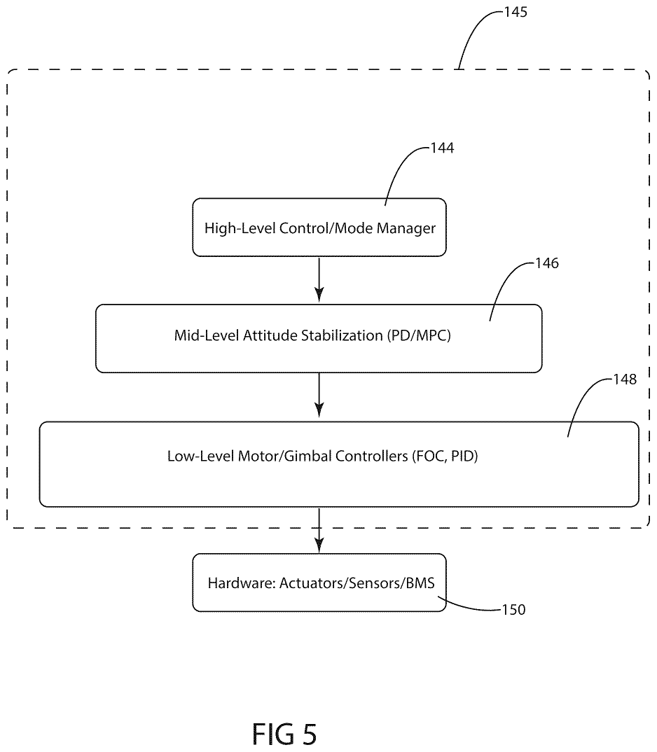

FIG. 5 is a flowchart of control hierarchy and loops. A control subsystem comprises a processor (microcontroller, microprocessor, or FPGA-based controller), referred to as the controller 145, motor drivers for rotor and gimbal actuators, memory for calibration and user profiles, and communication interfaces (e.g., Bluetooth Low Energy) to external devices (smartphones, clinician consoles). The control architecture includes multiple nested loops. High-Level 144, Mid-Level 146 and Low-Level 148 controllers inform the hardware including Actuators/Sensors and BMS 150.

A High-Level Control/Mode Manager 144 controls decision logic and mode management. This control determines operating mode. Some modes include continuous assist, event-triggered assist, therapy/exercise mode, training mode, passive mode, or transport/locked mode. Continuous assist mode involves constant torque to keep the user in a preferred orientation. Event-triggered assist mode monitors sensors and provides torque to counteract a sensor triggered event. Therapy/exercise mode provides torque in specific directions according to muscle groups requiring therapy. Training mode provides a program designed to challenge the balance of the user or to work specific muscle groups and may include game-like scoring. A passive mode provides light torque in multiple directions. A transport, or locked mode locks motor actuators to prevent movement during transport. The high-Level Control/Mode Manager 114 further manages energy-saving behavior (e.g., reduced assist when battery low) and supervises safety monitors.

A Mid-Level Control 146 is an attitude stabilization loop. The attitude stabilization loop computes desired torque vector based on estimated posture deviation (angle and angular rate errors) and issues torque commands to low-level controllers. Typical implementations include PD or PID controllers, with gain-scheduling based on activity (standing, walking) and user profile.

A Low-Level Motor/Gimbal Controller 148 includes motor controllers that provide speed/torque control loops for rotors and position/velocity control for gimbals using PID or high-performance controllers. These loops operate at high sample rates (e.g., 500 Hz-1 kHz) as required for stable actuation.

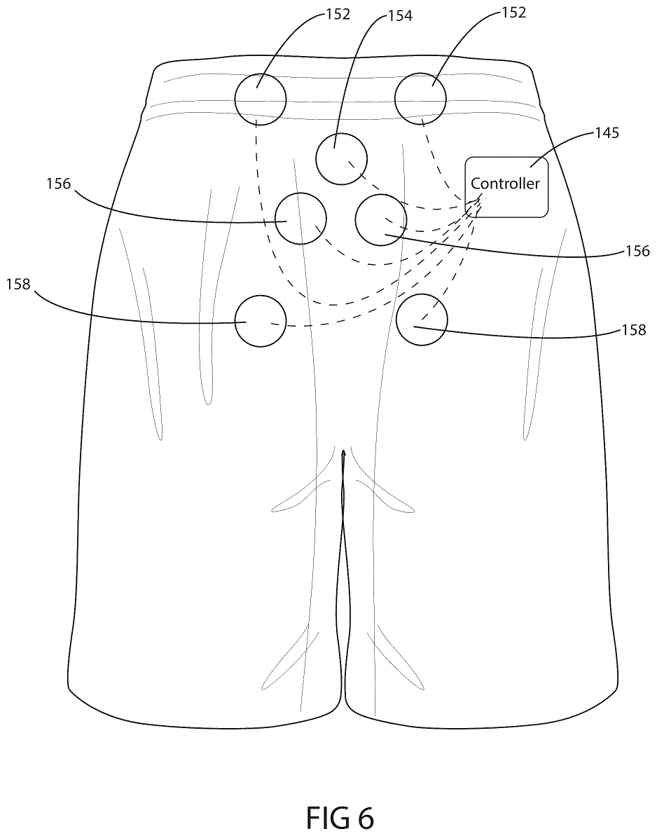

FIG. 6 is a distributed reaction wheel array embedded in a garment. A Distributed Micro-reaction Wheel Garment with multiple gamified training micro reaction wheel modules embedded in a garment that communicate wirelessly with a central controller. Modules produce coordinated torques to achieve the desired net moment while distributing mass to improve comfort. A therapy application delivers gamified balance challenges (timed tasks, scoring) that adjust difficulty via torque modulation and provide biofeedback to encourage adherence.

In this example embodiment a set of gyroscopes are embedded in a pair of shorts. A first pair of gyroscopes 152 are configured to control pitch, i.e. tilting forward or backward, having a flywheel rotating about a horizontal axis from the front to the rear of the wearer. A second set of flywheels 156 are configured to control roll, tilting from side to side, having a flywheel rotating about a horizontal axis extending from the user's right side to the user's left side. A third set of flywheels 158 are configured to control yaw, or twisting clockwise or counterclockwise, having a vertical axis. A gimbal-controlled moment gyroscope (GMB) 154 is configured to accentuate the torque of paired gyroscopes 152, 156 and 158, when additional torque is required to right the user. Each gyroscope in the paired gyroscopes 152, 156 and 158 and the GMB 154 are wirelessly connected to the controller 145 (FIG. 5, FIG. 6).

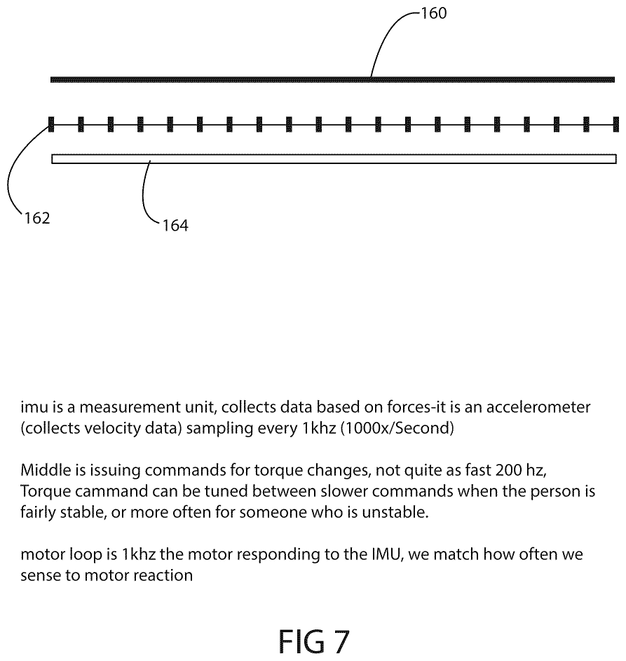

FIG. 7 is a safety subsystem block diagram depicting the relationship between sensors, including at least one Inertial Measurement Unit (IMU) 160, torque command 162, communication from the controller to the motor referred to as the motor loop 164. Sensors and Sensing Subsystem Primary sensors typically include at least one IMU 160 mounted on the carrier and, optionally, additional IMUs mounted on the torso and/or limbs.

The term torque command 162 refers to a computed moment, expressed about one or more axes, that the system will apply to the carrier via gyroscopic action. A sensor subsystem 160, including IMUs, foot-contact sensors, optional environmental sensors, is configured to sense state information related to orientation, motion, gait phase, or user-environment interactions. A control subsystem operatively coupled to the sensor subsystem sends signals to control the gyroscopic stabilization elements, referred to here as the motor loop 164. The control subsystem is configured to determine corrective torque commands based on the sensed state information and to operate the gyroscopic stabilization elements to apply corrective torques to motors on gyroscopes in the carrier to assist in stabilizing the wearer.

The sensor subsystem and a control subsystem perform sensor fusion and compute corrective torque commands. Controlled changes of rotor speed and/or gimbal orientation 164 generate torques in one or more axes to assist a wearer in maintaining balance and to provide therapist-or user-configurable therapy and exercise modalities. In an example embodiment IMU(s) 160 collect data, sampling at a rate of 1 khz (1000 times/second). Torque commands 162 issued for torque changes operate at 200 hz. Torque commands can be tuned between slower commands, less than 200 hz when the user is stable, or faster (more frequent) commands, at a rate greater than 200 hz for a user who is less stable. The motor loop 164 responds at a rate of 1 khz to the rate of measurements in the IMU.

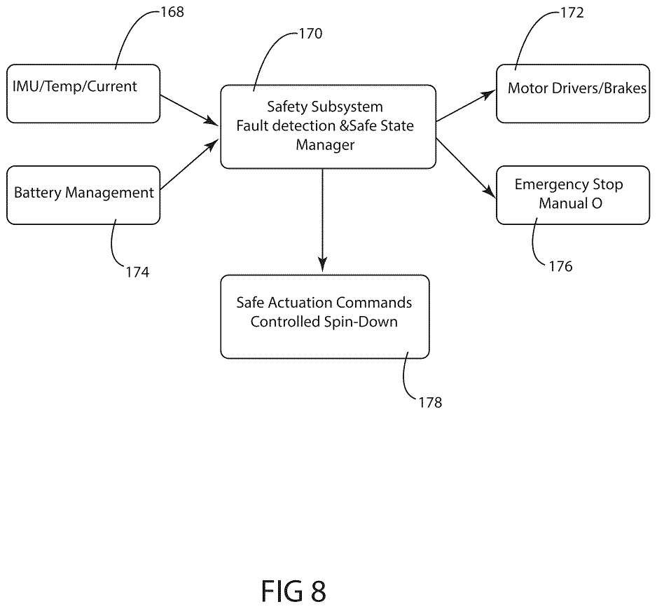

FIG. 8 is a timing diagram illustrating sensor sampling and torque-command updates. The IMU set temperature and current measurement 168 monitors IMUs and cross-checks sensor faults to trigger safe fallback through the safety subsystem 170. The battery management system 174 is monitored by a safety subsystem fault detection and safe-state manager 170, that generally controls safe actuation commands during operation and controlled spin-down 178 during a normal shut down operation of the system. If a fault or emergency stop occurs, rotors are decelerated in a controlled manner to minimize abrupt torque transients; mechanical brakes, eddy-current dampers, or resistive braking may be included to safely arrest rotor motion.

In an example embodiment, during controlled rotor deceleration or braking, motor drivers may operate in regenerative modes to recover a portion of kinetic energy back into the battery or into local capacitive storage, improving overall energy efficiency. The safety subsystem 170 further monitors battery state of charge (SOC) and adjusts assist aggressiveness, permitted rotor acceleration rates, or axis coverage (e.g., disabling a lower-priority axis) to conserve energy while maintaining essential stabilization or therapy safety.

In other examples the safety subsystem 170 controls a number of safety protocols when necessary. Charging, for example, may be via standard DC connectors, USB-C PD where compatible, or proprietary fast-charge interfaces. Safety features include isolation, fail-safe charge cutoffs, and enclosure design to minimize heat transfer to the wearer during charging or heavy use. The safety subsystem 170 may control motor drivers and brakes 172 if temperatures reach a critical level, or if flywheel speed exceed a safe level, for example. Additional, maximum allowable torque and angular acceleration limits are enforced in the hardware and firmware to prevent excessive, uncomfortable, or destabilizing torques.

In another example when temperatures rise at a rate beyond a usual threshold, an emergency stop action 176 may be initiated by the safety subsystem 170.

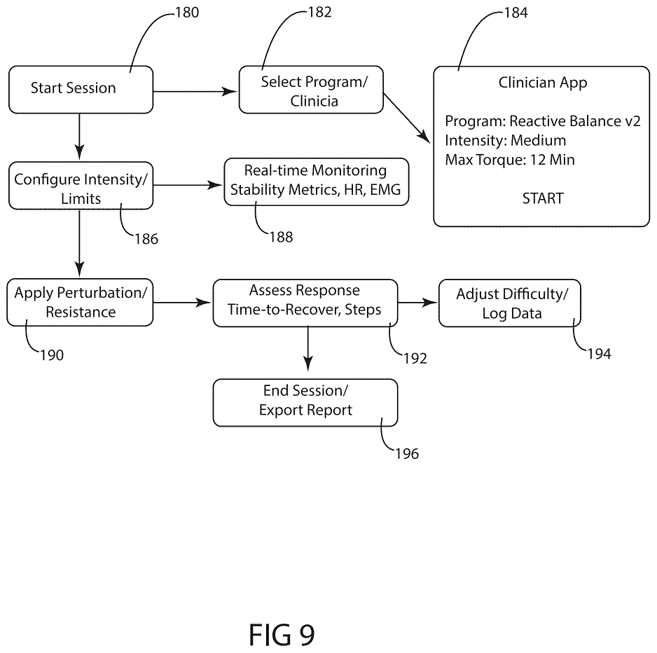

FIG. 9 is an example therapy/exercise mode flowchart and clinician interface schematic. In this example use a user interface allows the user to start a session 180 and choose to select a program 182 which will follow to a clinician application 184, or to configure a specific exercise. The clinician application 184 sets a named program, intensity level and maximum gyroscope torque.

To configure a specific exercise the user chooses to confiture intensity and limits 186 which includes real-time monitoring, stability metrics 188. Further configurations may be made to apply perturbation or resistance 190 which will monitor and assess response time-to-recover 192 and allow the user to then adjust difficulty level and log data 194. The user interface then allows the user to end session and export a report 196

1. A wearable stabilization system comprising:
a carrier configured to be worn by a human user; and
a least one gyroscopic stabilization element coupled to the carrier, the gyroscopic stabilization element comprising a rotatable mass and a motor configured to rotate the mass about a spin axis; and
a sensor subsystem configured to sense state information related to at least one of an orientation, a motion, or a gait phase of the user; and
a control subsystem operatively coupled to the sensor subsystem and the at least one gyroscopic stabilization element, the control subsystem configured to:
receive the sensed state information: and
calculate a corrective torque command based on the sensed state information; and
actuate the at least one gyroscopic stabilization element to apply a corrective torque to the carrier to assist in stabilizing the user.

2. The system of claim 1 wherein:
the control subsystem is configured to operate in a continuous assist mode providing low-level stabilization torque to reduce postural sway.

3. The system of claim 1 wherein:
the control subsystem is configured to operate in an event-triggered assist mode configured to deliver a high-magnitude corrective torque only upon the sensor subsystem detecting a perturbation exceeding a predefined threshold.

4. The system of claim 1 wherein:
the control subsystem is configured to operate in a therapy mode wherein:
the control subsystem actuates the at least one gyroscopic stabilization element to provide a controlled perturbation sequence having a programmable magnitude and direction to train reactive balance.

5. The system of claim 1 wherein:
the control subsystem is configured to operate in a therapy mode wherein:
the control subsystem actuates the at least one gyroscopic stabilization element to provide a resistive torque profile configured to oppose a movement of the user to provide resistive loading to a target muscle group.

6. The system of claim 1 wherein
the control subsystem is configured to operate in a training mode that dynamically adjusts a difficulty level of a balance program by increasing or decreasing the corrective torque based on historical performance metrics wherein the performance metrics include at least one of a time-to-recovery or a postural sway amplitude.

7. The system of claim 1 wherein:
the at least one gyroscopic stabilization element comprises an orthogonal reaction wheel array having at least three rotatable masses configured to rotate about three substantially orthogonal axes, enabling independent torque generation in pitch, roll, and yaw.

8. The system of claim 1 wherein:
the at least one gyroscope stabilization element comprises a control moment gyroscope comprising:
at least one gimbal configured to reorient the spin axis of the rotatable mass; and
at least one gimbal motor configured to actuate the gimbal to produce a precessional torque.

9. The system of claim 1 further comprising:
an application for an electronic device having multi-axis accelerometers configured to communicate with the sensor subsystem; wherein
multi-axis accelerometer data is used to inform the sensor subsystem to determine said state information.

10. The system of claim 1 wherein:
the sensor subsystem comprises an inertial measurement unit and at least one contact sensor engaged with the user's body, the control subsystem utilizing data from the contact sensor to time the application of the corrective torque during a specific gait phase of the user; wherein
the control subsystem is configured to time the application of corrective torque to coincide with a stance phase of the user's gait cycle to reduce interference during walking.

11. The system of claim 10 wherein:
the at least one contact sensor is engaged with at least one of the user's feet.

12. The system of claim 1 wherein:
the control subsystem implements a control algorithm selected from the group consisting of proportional-derivative control, proportional-integral derivation control, model predictive control and adaptive learning-enabled control.

13. The system of claim 1 further comprising:
a user interface configured to select an operating mode from the group consisting of continuous assist, event-triggered assist, training mode, therapy mode, exercise mode, passive mode and transport mode.

14. The system of claim 1 further comprising:
a safety subsystem configured to monitor at least one of a battery state of charge, a motor temperature, or a flywheel speed, and initiate a controlled spin-down of the rotatable mass upon detection of a fault condition.

15. The system of claim 1 wherein:
the carrier is a garment, and the at least one gyroscopic stabilization element comprises a plurality of distributed micro-reaction wheels embedded within the garment and configured to communicate wirelessly with the control subsystem.

16. A wearable stabilization system comprising:
a wearable carrier configured to be secured to a user's torso; and
a control moment gyroscope module coupled to the carrier, the CMG module comprising:
a flywheel coupled to a flywheel motor and configured to rotate about a spin axis; and
a gimbal frame supporting the flywheel; and
a gimbal actuator configured to rotate the gimbal frame about a gimbal axis, wherein the gimbal axis is substantially perpendicular to the spin axis; and
a sensor subsystem comprising at least one inertial measurement unit configured to detect an angular deviation of the user; and
a controller configured to actuate the gimbal actuator to reorient the spin axis of the flywheel in response to a detected angular deviation, thereby generating a precessional torque to stabilize the user.

17. The system of claim 16 wherein:
the control moment gyroscope module further comprises a second gimbal frame and a second gimbal actuator configured to rotate the flywheel about a third axis perpendicular to both the spin axis and the first gimbal axis, enabling multi-axis torque generation.

18. The system of claim 16 wherein:
the controller is configured to execute a high-frequency torque loop that adjusts the velocity of the gimbal actuator at a rate of at least 500 Hz to counteract sudden postural perturbations.

19. The system of claim 16 wherein:
the wearable carrier comprises a vest; and
the control moment gyroscope module is integrated into a posterior portion of the vest to align the generated precessional torque with the user's center of mass.

20. The system of claim 16 further comprising:
a safety brake coupled to the gimbal frame, the controller configured to engage the safety brake and initiate a controlled spin-down of the flywheel upon detecting a system fault or a torque limit.

21. The system of claim 16 wherein:
the controller includes a therapy mode configured to actuate the gimbal actuator to provide resistive torque profiles that oppose the user's natural movement to strengthen trunk musculature.
